(19) United States
(12) Patent Application Publication
(10) Pub. No.: US 2008/0205399 A1
(43) Pub. Date: Aug. 28, 2008

(54) Method and System for Routing in Communication Networks Between a First Node and a Second Node

(76) Inventors: Christophe Delesalle, Lannion (FR); Francois Bougant, Michel En Greve (FR); Mickael Salaun, Rosnoen (FR); Julie Gourdon, Moulineaux (FR)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/664,476

(22) PCT Filed: Sep. 28, 2005
(86) PCT No.: PCT/FR05/50791

§ 371 Date: Jan. 17, 2008

(30) Foreign Application Priority Data
Sep. 30, 2004 (FR) 0410366

(51) Int. Cl. H04L 12/28

(52) U.S. Cl. 370/392

(57) ABSTRACT

A system and a method of transmitting information between a first node (3) and a second node (5) interconnected by communications networks (7, 9), the first node (3) sending data to the second node (5) at two different addresses so that said data sent by the first node (3) to said two different addresses is routed over two different paths (13, 15) to a single network address (17) of the second node (5).

### TECHNICAL FIELD OF THE INVENTION

The invention relates to the field of transmission of information between a first node and a second node interconnected by means of telecommunications networks and in particular IP data networks. The invention may be applied in the field of metering and billing Internet services.

### BACKGROUND OF THE INVENTION

FIG. 8 shows a prior art system for transmitting information between a first node 103 corresponding to a client 103a and a second node 105 corresponding to a server 105a. The client 103a and the server 105a are interconnected by communications networks 107 and 109.

In the prior art the server 105a is configured to provide services at different network addresses.

In fact, the client 103a sends the server 105a data with two different addresses 117a and 117b corresponding to two different URLs.

The streams or data are separated between two paths 113a and 115 and sent to the server 105a over different physical or logical interfaces. Under such circumstances, the server 105a has as many logical connections to the networks 107 and 109 as it has different addresses 117a and 117b.

The fact that the server 105a has a plurality of addresses 117a and 117b in the networks 107, 109 to which it is connected constitutes a major drawback, especially if it is connected to the Internet, because of the shortage of public IP addresses.

Furthermore, the duplicated connection of the server 105a to the networks is linked to the type of access used by the server 105a and depends on whether that type of access is able to support two simultaneous IP connections. If the type of access used is not able to support a duplicated connection (for example PSTN), or if the access operator does not allow it (for example for non-business access), the server 105a must be connected to the networks 107 and 109 by two separate physical connections 116 and 126.

Moreover, the data sent by the server 105a to the client 103a over the paths 113a and 115 always returns via the same path 113b because, according to the Internet Protocol (IP), the server 105a uses the same path 113b to route data to the same client 103a having only one address 119. The data streams are therefore asymmetrical on each of the paths or links, which limits their analysis (for example for statistical, quality control or bandwidth management purposes) to the application level.

### OBJECT AND SUMMARY OF THE INVENTION

An object of the invention is to remedy the above drawbacks and to simplify the connection of the server to the communications networks.

Another object is to distinguish application (for example chargeable) streams between a client and a server connected to the Internet in order to cost and where appropriate bill them.

The above objects are achieved by means of a method of transmitting information between a first node and a second node interconnected by communications networks, the first node sending data to the second node at two different addresses, so that said data sent by the first node to said two different addresses is routed over two different paths to a single network address of the second node.

Having a single and unique address, it suffices for the second node to have a single simple connection to the networks. Accordingly, although proposing a plurality of services, it is sufficient for a server to have a single physical line for access to a telecommunications network and in particular to a public IP network.

Furthermore, the fact that the data is routed over two different paths enables certain data to be distinguished from other data, for example in order to cost data taking one of the two paths.

According to one aspect of the invention, one of said two addresses corresponds to the single network address of the second node and the other address corresponds to an address assigned to a proxy router connected to the first and second nodes so that one of the two paths passes through the proxy router.

The address assigned to the proxy router is advantageously interchanged with the single address of the second node in accordance with a static and/or dynamic NAT/PAT function.

According to another aspect of the invention, data sent from the first node to the second node takes the same path as data sent from the second node to the first node.

The first and second nodes correspond to a terminal and a server of a client-server system.

According to a further aspect of the invention, the address assigned to the proxy router is exchanged with a single address of one of a plurality of servers in accordance with an application NAT/PAT function enabling the plurality of servers to share the proxy server.

Data exchanged between the first and second nodes corresponding to the terminal and to the server of the client-server system and taking the path passing through the proxy router is advantageously further analyzed in accordance with an application metering function, thereby enabling said data to be costed.

The invention is also directed to a system for transmitting information between a first node and a second node interconnected by means of communications networks, the first node sending data to the second node at two different addresses, the system including routing means enabling said data sent by the first node to said two different addresses to be received by the second node at a single network address via two different paths.

The routing means of the transmission system include a proxy router connected to the first and second nodes so that one of said two addresses corresponds to an address assigned to the proxy router so that one of the two paths passes through the proxy router, the other address being said single network address of the second node.

The routing means advantageously further include application metering means adapted to analyze data exchanged between the first and second nodes corresponding to a terminal and to a server of a client-server system and taking the path passing through the proxy router, thereby enabling said data to be costed.

The information transmission system further includes a management center adapted to receive information from the application metering means concerning data passing through the proxy router in order to cost that data and to bill a client of the client-server system accordingly.

The routing means further include a switching router adapted to switch data streams between the communications networks as a function of the destination addresses.

The invention is further directed to routing means connected to a first node and to a second node interconnected by communications networks, the first node sending data to the second node at two different addresses, wherein the routing means include a proxy router enabling said data sent by the first node to said two different addresses to be received by the second node at a single network address via two different paths one of which passes through the proxy router.

The routing means advantageously further include application metering means adapted to analyze data taking the path through the proxy router.

### BRIEF DESCRIPTION OF THE DRAWINGS

Other features and advantages of the invention emerge on reading the following description given by way of non-limiting illustrative example and with reference to the appended drawings, in which:

FIG. 1 shows highly diagrammatically one example of a system in accordance with the invention for transmitting information between a first node and a second node interconnected by means of communications networks;

FIG. 2 shows one embodiment of the information transmission system from FIG. 1;

FIG. 3 shows one example of a method of transmitting information between a client and a server by the system from FIG. 2;

FIG. 4 shows another embodiment of the system in accordance with the invention for transmitting information between the first and second nodes;

FIG. 5 shows a system in accordance with the invention for transmitting information between a client and a plurality of servers with only one public address assigned to a single proxy router;

FIG. 6 shows an information transmission system according to FIG. 2 comprising application metering means;

FIG. 7 shows one example of a method of transmitting information between a client and a server by the system from FIG. 6; and

FIG. 8 shows highly diagrammatically an example of a prior art system for transmitting information between a first node and a second node interconnected by means of communications networks.

### DETAILED DESCRIPTION OF EMBODIMENTS

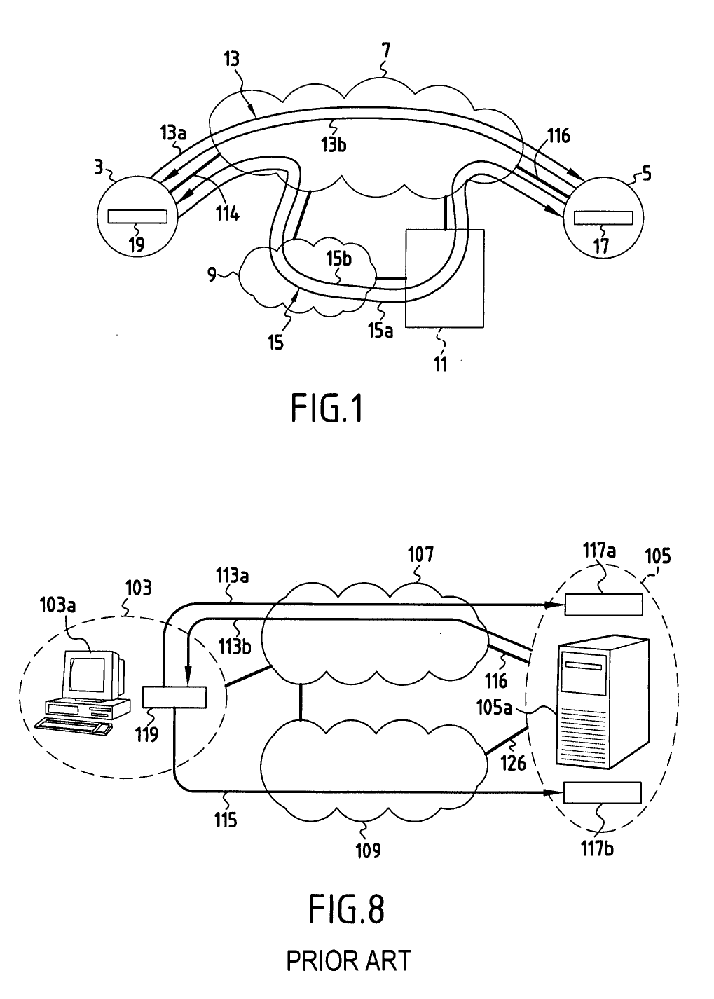

FIG. 1 shows highly diagrammatically an example of a system according to the invention for transmitting information between a first node 3 and a second node 5 interconnected by communications or telecommunications networks 7 and 9.

The system includes routing means 1 connected to the first and second nodes enabling streams or data sent by the first node 3 to two different addresses to be received by the second node 5 at a single network address 17 via two different paths 13a and 15a.

Of course, the routing means 11 also enable data sent by the second node 5 to two different addresses to be received by the first node 3 at a single network address 19 via two different paths 13b and 15b.

Thus the first node 3 and/or the second node 5 can have a single simple connection to the communications network 7. It then suffices for each of the first and second nodes 3 and 5 to have a single physical line 114 and 116, respectively, for access to the Internet.

The method according to the invention then consists in implementing a routing function in a communications network using URLs. Thus data or streams between the first node 3 and the second node 5 are routed to a single network address 17 or 19 via different links or paths 13 and 15 according to the name of the node defined in the URL of the application.

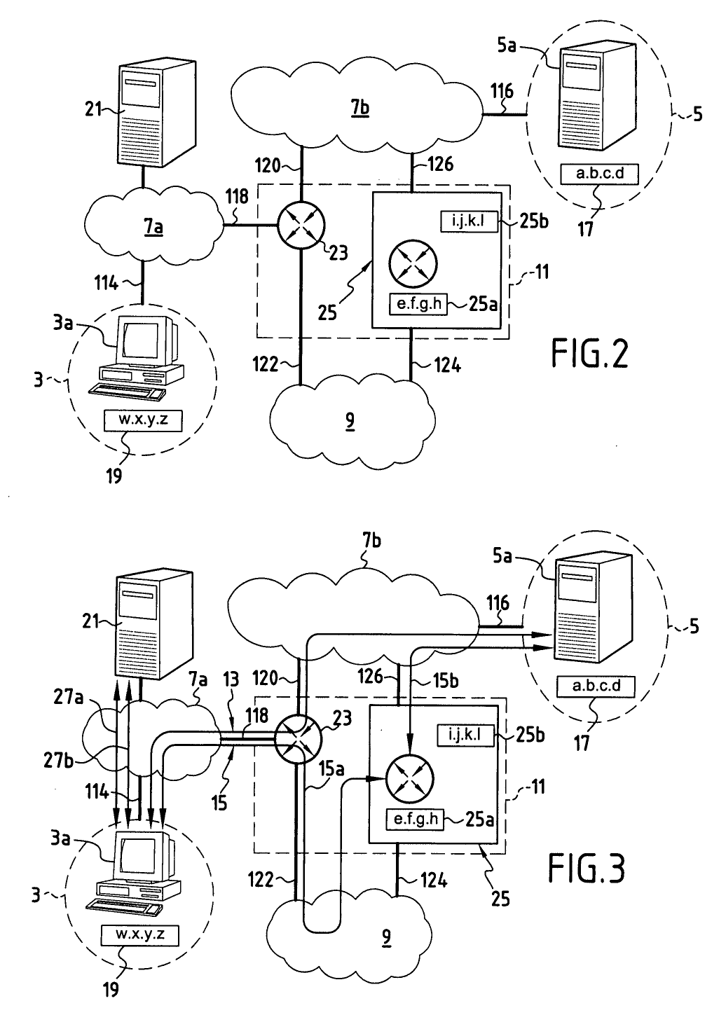

FIG. 2 shows one embodiment of the information transmission system from FIG. 1.

In this example, the first and second nodes 3, 5 of the information transmission system correspond to a terminal 3a and server 5a of a client-server system 3a-5a. In particular, the first node 3 corresponds to the terminal or client 3a and the second node 5 corresponds to the server 5a.

The client 3a and the server 5a are connected in a simple manner by connections 114 and 116 to IP communications networks 7a and 7b each having only a single IP address 17, 19 in the network to which they are connected. For example, the server 5a has the network address 17 (a.b.c.d) corresponding to a URL address.

Moreover, the communications networks 7a, 7b and 9 may be cable or wireless IP networks, low-speed or high-speed PSTN, xDSL networks, WiFi networks, GPRS networks, satellite networks, cable networks, etc.

As a general rule, the information transmission system also includes a domain name server (DNS) 21 for translating the domain names in the URL addresses used by the client 3a of the client-server system.

Moreover, the routing means 11 include a switching router 23 connected to the networks 7a, 7b and 9 by connections 118, 120 and 122, respectively. This switching router 23 is adapted to switch IP data streams between the networks 7a, 7b and 9 as a function of the destination IP addresses.

Furthermore, according to the invention, the router means 11 include a proxy router 25 connected to the first and second nodes 3 and 5 by the communications networks 7a, 7b and 9. The proxy router 25 is more particularly connected to the networks 9 and 7b by the connections 124 and 126, respectively, and to the network 7a via the switching router 23. Thus one of the two paths taken by data circulating between the first and second nodes 3 and 5 passes through the proxy router 25.

Accordingly, if the client 3a or the first node 3 sends data to two different network addresses (for example the addresses e.f.g.h and a.b.c.d), one of the two addresses (for example the address e.f.g.h) corresponds to a first address 25a assigned to the proxy router 25 and the other address (a.b.c.d) corresponds to the unique network address 17 of the server 5a or the second node 5. Accordingly, if the address sent by the client 3a is that of the proxy router 25, i.e. the address (e.f.g.h), the data transmitted by the client 3a reaches the server 5a along a path that passes through the proxy router 25 which, as it passes through it, replaces its first network address 25a with the unique network address 17 of the server 5a, using a static NAT/PAT network or protocol address translation function.

Likewise, if the server 5a or the second node 5 sends data to two different addresses (for example the addresses i.j.k.l and w.x.y.z), one of the two addresses (for example the address i.j.k.l) corresponds to a second network address 25b assigned to the proxy router 25 and the other address (w.x.y.z) corresponds to the unique network address 19 of the client 3a or the first node 3. In other words, the data sent from the first node 3 to the second node 5 takes the same path (paths 13 and 15 in FIGS. 1 and 3) as that sent from the second node to the first node 3.

The FIG. 2 information transmission system uses simple and standardized protocols and mechanisms (DNS, IP routing and NAT/PAT) and standard robust equipment (DNS and router) offering high performance.

FIG. 3 shows an example of the method of transmission of information between the client 3a and the server 5a by the FIG. 2 system.

First of all, the client 3a resolves the name of the server 5a to the domain name server (DNS) 21 of its Internet Service Provider (ISP) (paths 27a, 27b), which sends back to it the network address 17 (a.b.c.d) (path 27a) of the server 5a or the network address 25a (e.f.g.h) of the proxy router 25 corresponding to the name contained in the URL used in the application of the client 3a that is operationally associated with the server 5a (path 27b).

For the application and the URL used, the client 3a and the server 5a communicate directly with each other over the path 13 using their real IP addresses (w.x.y.z for the client 3a and a.b.c.d for the server 5a) if the address sent back by the DNS 21 is the real address 17 of the server 5a.

However, if the address sent back by the DNS 21 is the address of the proxy router 25 (path 27b), then the client 3a sets up the session with the server 5a along the path 15 passing through the proxy router 25. The proxy router 25 modifies the IP streams that it is routing as they pass through it, in accordance with a static and/or dynamic NAT/PAT function, as follows:
Static NAT/PAT: the network address 17 (a.b.c.d) of the server 5a is exchanged for the first network address 25a (e.f.g.h) of the proxy router 25 and vice-versa (e.f.g.h [symbol] a.b.c.d). The static NAT/PAT function defines a one-to-one relationship between the address 17 of the server 5a and the first address 25a of the proxy router 25.
Dynamic NAT/PAT: the network address 19 (w.x.y.z) of the client 3a is exchanged for the second network address 25b (i.j.k.l) of the proxy router 25 and vice-versa (w.x.y.z [symbol] i.j.k.l). The dynamic NAT/PAT function defines an N-to-one relationship between N addresses 19 of N clients 3a and the second address 25b of the proxy router 25, for example.

For each URL, IP streams or packets transmitted from the server 5a to the client 3a then take the same path 13 or 15 as those transmitted from the client 3a to the server 5a. The streams taking different paths 13 and 15 in the network are therefore symmetrical.

Note that, between the client 3a and the proxy router 25 (path 15a), the IP streams contain the real IP address 19 (w.x.y.z) of the client 3a and the concealed address (e.f.g.h) of the server 5a. In contrast, between the proxy router 25 and the server 5a (path 15b), the IP streams contain the concealed IP address (i.j.k.l) of the client 3a and the real address 17 (a.b.c.d) of the server 5a.

Accordingly, the client 3a has the impression of dealing with two different machines whereas it is in fact dealing with the same server 5a. Similarly, the server 5a that operates the service has the impression of serving two separate clients although it is really the same client 3a that accesses the services via two different URL.

Note that the transmission of data between the first and second nodes 3 and 5 is not limited to only two paths and may use a plurality of paths.

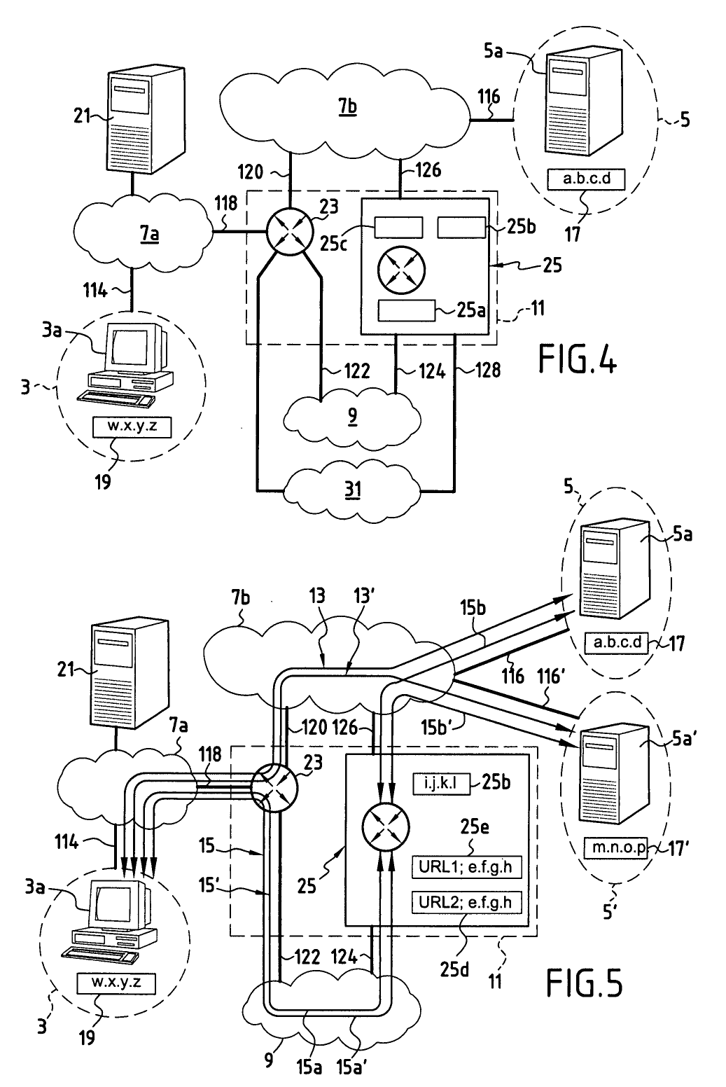

In fact, FIG. 4 shows another embodiment of the system for transmitting information between the first and second nodes 3 and 5 that is distinguished from that from FIG. 2 only by virtue of the fact that the switching router 23 and the proxy router 25 are connected to a additional communications network 31 enabling transmission of information between the client 3a and the server 5a along a third path. Under such circumstances, three network addresses 25a, 25b and 25c are assigned to the proxy router 25.

Having the information transmission system include a additional proxy router for each additional communications network may also be envisaged.

It is advantageously also possible to cover a plurality of servers with a single public address assigned to a single proxy router 25.

In fact, FIG. 5 shows a system for transmitting information between a first node 3 corresponding to a client or terminal 3a, one second node 5 corresponding to a first server 5a and another second node 5′ corresponding to a second server 5a′. The servers 5a and 5a′ are connected in a simple manner by the connections 116 and 116′ to the communications network 7b and the terminal 3a is connected in a simple manner by the connection 114 to the communications network 7a.

The terminal 3a has only one address 19 and, likewise each of the first and second servers 5a and 5a′ has only one IP address 17 and 17′, respectively.

For example, the client 3a has the network address 19 corresponding to a URL address (w.x.y.z), the first server 5a has the network address 17 corresponding to a URL address (a.b.c.d), and the second server 5a′ has the network address 17′ corresponding to a URL address (m.n.o.p).

Accordingly, if the client 3a sends data to the real network address (a.b.c.d) of the first server 5a, then the client 3a and the first server 5a communicate directly with each other along the path 15.

Similarly, if the client 3a sends data to the real network address (m.n.o.p) of the second server 5a′, then the client 3a and the second server 5a′ communicate directly with each other over the path 15′.

However, if the client 3a sends data to the server address assigned to the proxy router 25, then the client 3a sets up the session with the first server 5a or the second server 5a′ according to the domain name used by the client 3a.

In fact, the proxy router 25 exchanges its address for a unique address of one of the two servers 5a and 5a′ according to an application NAT/PAT function that associates a single and unique server address as a function of the domain name for each pair consisting of a domain name used by the client 3a and the address assigned to the proxy router 25. In other words, the application NAT/PAT function defines a one-to one association between a single server IP address and each pair comprising a URL and the server IP address of the proxy router. This therefore makes it possible to use a single public IP address (a.b.c.d or m.n.o.p) as the server IP address for each server 5a, 5a′.

In fact, the public IP address (e.f.g.h) assigned to the proxy router 25 suffices for sharing a plurality of servers. Accordingly, as a general rule, the proxy router 25 can exchange its address (e.f.g.h) for a unique address of one of a plurality of servers according to the application NAT/PAT function, thereby enabling the plurality of servers to share the proxy router 25. Accordingly, pooling the proxy server 25 for a plurality of servers saves on public IP addresses.

According to the FIG. 5 example, if the client 3a sends data to the address (e.f.g.h) assigned to the proxy router 25 using a first domain name URL1, i.e. in accordance with the pair (URL1; e.f.g.h) 25e, then the client 3a sets up the session with the first server 5a along the path 15 passing through the proxy router 25.

Likewise, if the client 3a sends data to the address assigned to the proxy router 25 using a second domain name URL2, i.e. according to the pair (URL2; e.f.g.h) 25d, then the client 3a sets up the session with the second server 5a′ along the path 15′ passing through the proxy router 25.

Note that the method of transmitting data in the opposite direction, i.e. from the servers 5a, 5a′ to the client 3a, is identical to that described above with reference to FIGS. 2 and 3.

The method according to the invention thus enables two or more IP streams to be separated according to the URL used at the application level. In other words, this method extracts application streams characterized by the URL used by the client-server system 3a-5a in a raw IP stream exchanged between the client 3a and the server 5a.

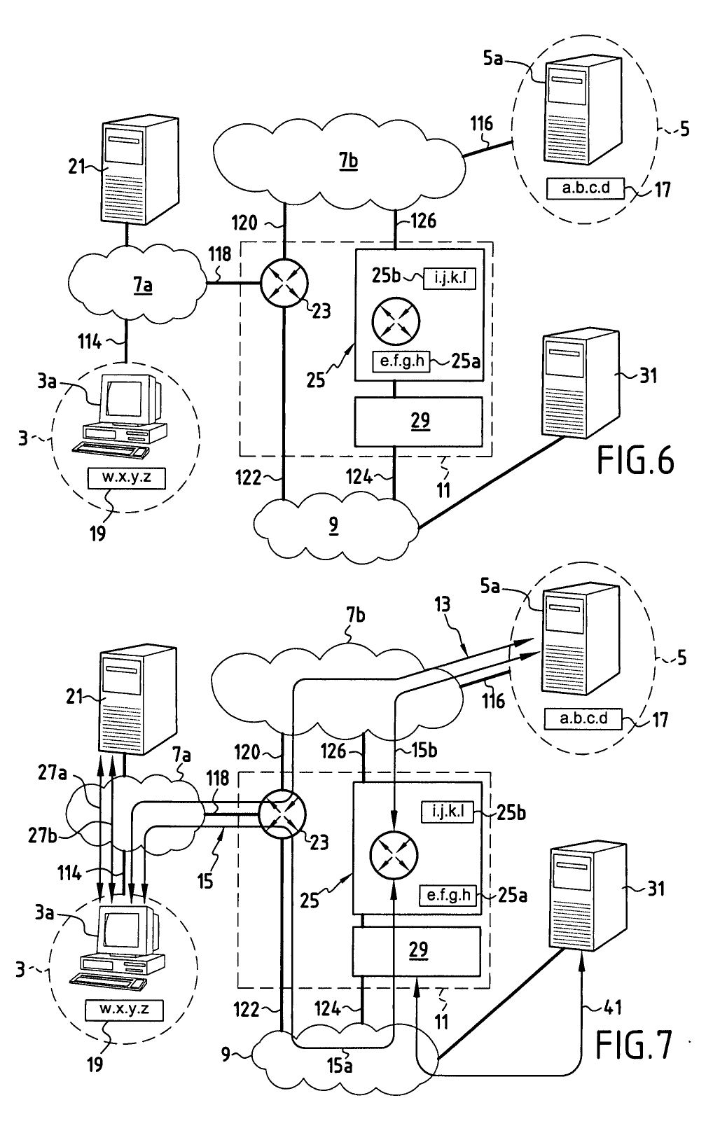

FIG. 6 shows an information transmission system including application metering means 29.

The application metering means 29 analyze data exchanged between the first and second nodes 3, 5 corresponding to the terminal 3a and the server 5a of the client-server system taking the path 15 through the proxy server 25.

The routing means 11 therefore route data exchanged between a client 3a and a server 5a connected to the Internet and analyses only data that passes through the proxy router 25, in order to cost and/or bill it.

The application metering means 29 or the application metering function can be implemented in the switching router 23, the proxy router 25 or equipment situated between the switching router 23 and the proxy router 25.

Moreover, the routing means 11 including the application metering function may use any type of application protocol (for example HTTP, RTSP, MMS, FTP).

Note that the client 3a, the server 5a, and the routing means 11 may be independently located anywhere in the world.

As before, the client 3a and the server 5a are connected to the Internet network and each of them has a routable public IP address 17, 19 (w.x.y.z for the client 3a and a.b.c.d for the server 5a).

Accordingly, the domain name server 21 of the Internet Service Provider sends the IP addresses of the server 5a and the proxy router 25 as a function of the service name that it is required to resolve. For example, for a service that is free of charge it sends the IP address (a.b.c.d) of the server 5a and for a chargeable service it sends the server IP address (e.f.g.h) of the proxy router 25.

The switching router 23 extracts IP streams sent from the client 3a to the proxy router 25. According to the invention, the proxy router 25 has two interfaces, each of which has a separate IP address 25a, 25b: the server IP address (e.f.g.h) of the proxy router 25 is the IP address that the client 3a or the Internet surfer uses on application (for example chargeable) streams exchanged with the server 5a and the client IP address (i.j.k.l) is the address that the proxy router 25 uses to conceal from the server 5a the real address of the client 3a that is consuming the chargeable service. The proxy router 25 routes the IP streams between the client 3a and the server 5a, applying in each direction static NAT/PAT functions to the address of the server 5a (e.f.g.h is interchanged with a.b.c.d) and dynamic NAT/PAT functions to the address of the client 3a (w.x.y.z is interchanged with i.j.k.l).

Accordingly, the server 5a proposes its services to Internet surfers or clients 3a via two virtual servers each operating under a different domain name. Access to the virtual server managing the domain that is free of charge is therefore not filtered. In contrast, access to the virtual server managing the chargeable domain is authorized only for IP frames coming from the proxy router 25 (source IP address i.j.k.l).

The information transmission system further includes a management center 31 adapted to receive information from the metering means concerning the data passing through the proxy router 25 in order to cost that data and to bill a client 3a of the client-server system accordingly.

FIG. 7 shows in detail applications of the information transmission system from FIG. 6. In a first application, the server 5a is a multiservice server proposing two types of service.

For example, the first service is a free service under the domain name www.myfreedomain.com for presentation of general information and the second service is a chargeable service under the domain name www.mychargeabledomain.com for presentation of specific information.

The Internet surfer or the client 3a first logs onto to the Internet to access the service proposed by the service provider. It resolves (27a) the server name www.myfreedomain.com to the domain name server 21 of its Internet Service Provider, which sends it the real IP address (a.b.c.d) of the server 5a. The surfer therefore accesses the public home pages of the server 5a (for example presentation of the service, access conditions, tour of free pages) via the path 13.

The server 5a then prompts (path 13) the client 3a to access chargeable pages characterized by another URL www.mychargeabledomain.com. wishing to access these chargeable pages, the client 3a selects the new URL and therefore again resolves (27b) the name to the domain name server 21 of the client's Internet service provider, which returns the server IP address (e.f.g.h) of the proxy router 25. IP streams from the client 3a are therefore directed along the path 15 to the server 5a via the proxy router 25 which replaces its server IP address in the IP frames with the real IP address of the server 5a (e.f.g.h [symbol] a.b.c.d) and replaces the real IP address of the client 3a with its own client IP address (w.x.y.z [symbol] i.j.k.l).

The IP streams taking the path 15a between the client 3a and the proxy router 25 contain the real IP address (w.x.y.z) of the client 3a and the concealed address (e.f.g.h) of the server 5a. IP streams taking the path 15b between the proxy router 25 and the server 5a contain the concealed IP address (i.j.k.l) of the client 3a and the real address (a.b.c.d) of the server 5a.

The path 15 therefore passes through the application metering means 29, which examine the application streams relating to the specific information used by the client 3a of the client-server system and send the management center 31 metering tickets for billing the client 3a (path 41).

The application metering means 29 providing metering by item, by duration and by volume, so that billing can be very flexible. Moreover, they verify if the service was provided correctly to the client and constitute a trusted third party in the event of a dispute between the service provider and the client.

Furthermore, the routing means 11 with the application metering means 29 do not need to be over-specified in terms of application analysis performance, because it is not necessary to analyze all of the streams between the client 3a and the server 5a, only those in transit on the path 15 passing through the routing means 11.

For example, the first service of the server 5a may be a web (HTTP) service presenting a catalogue of music or video clips under the URL www.videocatalogue.com (paths 27a, 13).

The second service may be a service for streaming music or video (for example RTSP, MMS) clips via the URL www.streaming.video-catalogue.com (paths 27b, 15). The streaming video streams pass through the metering means 29, which total the duration for which the client 3a uses this service and send a metering ticket to the management center 31 in order to cost this use and bill the client.

The streaming video streams may advantageously pass through an IP backbone for which the quality of service is guaranteed, in contrast to the Internet backbone, for which there is no guaranteed quality of service.

According to another example, the first service of the server 5a may be a free weather service that can be accessed by the client 3a in the conventional way via the Internet at the URL www.myfreeweather.com.

Via another URL www.mychargeableweather.com the same server 5a also proposes to the client 3a a second service providing more detailed forecasts for a time period and a location chosen by the client 3a.

The application metering means 29 may verify that the service (detailed weather reports) has been provided to the client 3a and send a ticket to the management center 31 for costing the service and billing it to the client 3a (paths 27b, 15).

According to a further example, a provider sells goods over the Internet for which the Internet Service Provider (ISP) bills the client.

First, the client 3a accesses the free service in the conventional way via the Internet at the URL www.mypublicpurchases.com and chooses its products (paths 27a, 13).

Then, via the URL www.myorderpurchases.com, the same server 5a is used to enter the details of the order from the client 3a and to validate the order (paths 27b, 15).

The application metering means 29 then analyze the HTTP requests and extracts from them the information necessary for billing the client (amount, vendor, date, etc.).

Finally, the ISP bills the internet surfer for the cost of the goods sold and transfers to the vendor of the goods the amount of the bill less a commission.

In a second application, the server 5a is a multiservice server proposing a first service presenting data accessible to the public (path 13) and a second service presenting secure data restricted to a particular group of clients or users (path 15).

In this application, the application metering means 29 quantify the secure data used by each client from this particular group of clients.

Accordingly, the information transmission system according to the invention may be used in all situations where the same server provides a plurality of services via separate networks.

1.-15. (canceled)

16. A method of transmitting information between a first node (3) and a second node (5) interconnected by communications networks (7, 9), the first node (3) sending data to the second node (5) at two different addresses, wherein said data sent by the first node (3) to said two different addresses is routed over two different paths (13, 15) to a single network address (17) of the second node (5), the first and second nodes (3, 5) corresponding to a terminal (3a) and a server (5a) of a client-server system.

17. The method according to claim 16, wherein one of said two addresses corresponds to the single network address (7) of the second node (5) and the other address corresponds to an address (25a) assigned to a proxy router (25) connected to the first and second nodes (3, 5) so that one of the two paths (13, 15) passes through the proxy router (25).

18. The method according to claim 17, wherein the address assigned to the proxy router (25) is interchanged with the single address of the second node (5) in accordance with a static and/or dynamic NAT/PAT function.

19. The method according to claim 16, wherein data sent from the first node (3) to the second node (5) takes the same path (13, 15) as data sent from the second node (5) to the first node (3).

20. A method according to claim 16, wherein the address assigned to the proxy router (25) is exchanged with a single address of one of a plurality of servers in accordance with an application NAT/PAT function enabling the plurality of servers to share the proxy server.

21. The method according to claim 16, wherein data exchanged between the first and second nodes (3, 5) corresponding to the terminal (3a) and to the server (5a) of the client-server system and taking the path (15) passing through the proxy router (25) is further analyzed in accordance with an application metering function, thereby enabling costing of said data.

22. A system for transmitting information between a first node (3) and a second node (5) interconnected by means of communications networks (7, 9), the first node (3) sending data to the second node (5) at two different addresses, wherein it includes routing means (11) enabling said data sent by the first node to said two different addresses to be received by the second node at a single network address (17) via two different paths (13, 15), the first and second nodes (3, 5) corresponding to a terminal and a server of a client-server system.

23. The system according to claim 22, wherein said routing means (11) include a proxy router (25) connected to the first and second nodes so that one of said two addresses corresponds to an address (25a) assigned to the proxy router (25) so that one of the two paths (15) passes through the proxy router (25), the other address being said single network address (17) of the second node (5).

24. The system according to claim 22, wherein said routing means (11) further include application metering means (29) adapted to analyze data exchanged between the first and second nodes (3, 5) corresponding to the terminal (3a) and to the server (5a) of the client-server system and taking the path (15) passing through the proxy router, thereby enabling costing of said data.

25. The system according to claim 24, wherein it further includes a management center (31) adapted to receive information from said application metering means (29) concerning data passing through the proxy router (25) in order to cost that data and to bill a client (3a) of the client-server system accordingly.

26. The system according to claim 16, wherein said routing means (11) further include a switching router (23) adapted to switch data streams between the communications networks as a function of the destination addresses.

27. Routing apparatus connected to a first node (3) and to a second node (5) interconnected by communications networks (7, 9), the first node (3) sending data to the second node (5) at two different addresses, wherein they include a proxy router (25) enabling said data sent by the first node to said two different addresses to be received by the second node at a single network address (17) via two different paths (13, 15) one of which passes through the proxy router.

28. The routing apparatus according to claim 27, further comprising application metering means (29) adapted to analyze data taking the path (15) through the proxy router (25).
